(19) United States
(12) Patent Application Publication
(10) Pub. No.: US 2015/0145230 A1
(43) Pub. Date: May 28, 2015

(54) BICYCLE BRAKE SYSTEM

(71) Applicant: BikeStreet USA, West Palm Beach, FL (US)

(72) Inventor: David L. Poole, Portland, IN (US)

(73) Assignee: BikeStreet USA, West Palm Beach, FL (US)

(21) Appl. No.: 14/090,189

(22) Filed: Nov. 26, 2013

(51) Int. Cl. B62L 3/02

(52) U.S. Cl. CPC B62L 3/02
USPC 280/210; 74/489

(57) ABSTRACT

A method and apparatus to brake a bicycle is disclosed. An elongated member is attach to a front mounting post of a bicycle and extends outward from the front mounting post in a substantially horizontal plane. The elongated member includes a pair of wide main sections respectively disposed adjacent the midsection and is adapted to support arms of a bicycle rider when the elongated member is attached to the front mounting post. A first recess is formed in the member bottom that is located adjacent a member end. A pin is coupled to the member and extends through the recess. The brake handle is positioned at least partially within each recess. A brake handle is rotatably coupled to the pin. The brake handles couples to a bicycle brake cable to brake the bicycle in response to a bicycle user partially rotating the handle about the pin within the recess.

### TECHNICAL FIELD

These claimed embodiments relate to a method for braking a bicycle and more particularly to a handlebar having integrated brake handles.

### BACKGROUND OF THE INVENTION

Most bicycles use brake levers to control the front and rear wheel braking action to slow down or stop the bicycle. It is considered a necessary and critical part of the bicycle. Brake levers are typically mounted on or near the handlebar to allow easy access for the cyclist hands to engage the brake handle.

Bicycles are human powered vehicles and therefore the efficiency of the bicycle is extremely important to achieve acceptable speed for competition racing bicycles. The efficiency of the bicycle depends on many variables. With modern technology the drive train efficiency on a competitive bicycle is 96% or higher. Friction of the drive components, rolling resistance of the wheels, etc. . . . are nearly perfect from an efficiency standpoint. Since the drive train efficiency has become nearly perfect on competition bicycles, it is well known within the sport that nearly all of the impedance to the cyclist speed is caused by air resistance. Therefore almost all of the development for faster bicycles has become centered on improving the aerodynamics of the bicycle and the cyclist's position.

There are many different disciplines and forms of bicycle racing. When cyclists are allowed to draft behind other cyclist or group of cyclists, there are specific rules to make sure the position of the cyclist and design of the bicycle does not compromise control and the safety of the sport. There are several disciplines in bicycle racing that do not allow riding closely behind another rider to work as a team or group. The sport of Triathlon (swim, bike, run) is one such example.

The sport of professional and more specifically non-professional triathlon has grown rapidly over the past 30 years since the first IronMan event was held in Hawaii. Therefore the market for competition bicycles specifically designed for triathlon racing has become significant.

A typical brake device for a Triathlon Bike (also referred to as TT Bike). includes a handlebar, external shifters, and brake levers. Short comings of these typical brake devices are that they have reduced aerodynamic efficiency. Further the brake levers stick out and can deeply puncture a bike rider in an accident. Also the nature of the handle makes it difficult to lower the profile height without losing the distance the cable is pulled.

### SUMMARY OF THE INVENTION

A bicycle handlebar is provided that includes an elongated member having a top and a bottom. The elongated member includes a narrow midsection that attaches to a front mounting post of a bicycle and extends outward from the front mounting post in a substantially horizontal plane. The elongated member includes a pair of wide main sections respectively disposed adjacent the midsection to support arms of a bicycle rider on the top when the elongated member is attached to the front mounting post. The member forms a first and second recess respectively disposed adjacent each end of the member on the bottom. A first and a second pin is coupled to the member and respectively extends through the first and second recess. A first and second brake handle is rotatably coupled to the first and second pin respectively. The first and second brake handle are at least partially disposed within each recess. The brake handles respectively couple to a front and rear brake cable of a bicycle to brake the bicycle in response to a partial rotation of the first or second brake handle about the first pin or the second pin within the recess by the bicycle user.

A method of braking a bicycle is disclosed. The method includes providing an elongated member with a top, a bottom, and a narrow midsection. Formed in the elongated member are a) a pair of wide main sections adjacent the narrow midsection, and b) a first recess and a second recess adjacent each end of the member on the bottom. A first and second pin are coupled to the member through the first and second recess respectively. A first and second brake handle are rotatably coupled to the first and second pin respectively such that the first and second brake handle are at least partially disposed within each recess. The narrow midsection is attached to a front mounting post of a bicycle such that the elongated member extends outward from the front mounting post in a substantially horizontal plane. The brake handles couples to a front brake cable and a rear brake cable of a bicycle respectively. The front brake cable couples to a bicycle front brake and the rear brake cable to a bicycle rear brake. Arms of a bicycle rider are supported on the top adjacent the wide main sections when the elongated member is attached to the front mounting post. The bicycle is braked with hands of the bicycle rider reaching below the attached member adjacent the first end or the second end to engage a rear section of the first or the second brake handle to at least partially rotate the first or the second brake handle about the first pin or the second pin within the recess.

A bicycle is provided that includes a bicycle frame with a front mounting post. A front wheel and a back wheel are coupled to the bicycle frame. A front brake and a rear brake are coupled to the bicycle for stopping rotation of the front wheel and back wheel. One end of a front cable engages with the front brake, and one end of a rear cable engages with the rear brake. The bicycle has a handlebar that includes an elongated member having a top and a bottom. The elongated member includes a narrow midsection attached to the front mounting post and extends outward from the front mounting post in a substantially horizontal plane. The elongated member includes a pair of wide main sections respectively disposed adjacent the midsection. The pair of wide main sections support the arms of a bicycle rider on the top adjacent the wide main sections. The member forms a first and second recess respectively disposed adjacent each end of the member on the bottom. A first and second pin are coupled to the member and respectively extend through the first and second recess. A first and second brake handle rotatably couple to the first and second pin respectively. The first and second brake handles includes a front section that extends from at least one of the pins forward away from the bicycle and a rear section that extends from at least one of the pins backward toward the bicycle. The first and second brake handle respectfully are at least partially disposed within the first and second recess. the front section of the front brake handle engages with the front brake cable and the front section of the rear brake handle engages the rear brake cable of the bicycle to brake the bicycle in response to a bicycle rider engaging with either the rear section of the front brake handle to partially rotate the front brake handle about the first pin within the recess, or the rear brake handle to partially rotate the rear brake handle about the second pin within the recess.

One purpose of the subject invention being disclosed is to improve the aerodynamics and safety of the brake lever and handlebar apparatus.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a top-side perspective view of a handle bar including a brake system and a shifting mechanism mounted on a bicycle.

FIG. 2 is a top perspective view of the handle bar including the brake system and shifting mechanism.

FIG. 3 is a bottom view of the handle bar including the brake system and shifting mechanism.

FIG. 4 is a top exploded view of the handle bar including the brake system and shifting mechanism.

FIG. 5 is a top-side exploded view of the handle bar including the rear brake system.

FIG. 6 is a top-side perspective view of a brake handle for the brake system.

### DETAILED DESCRIPTION

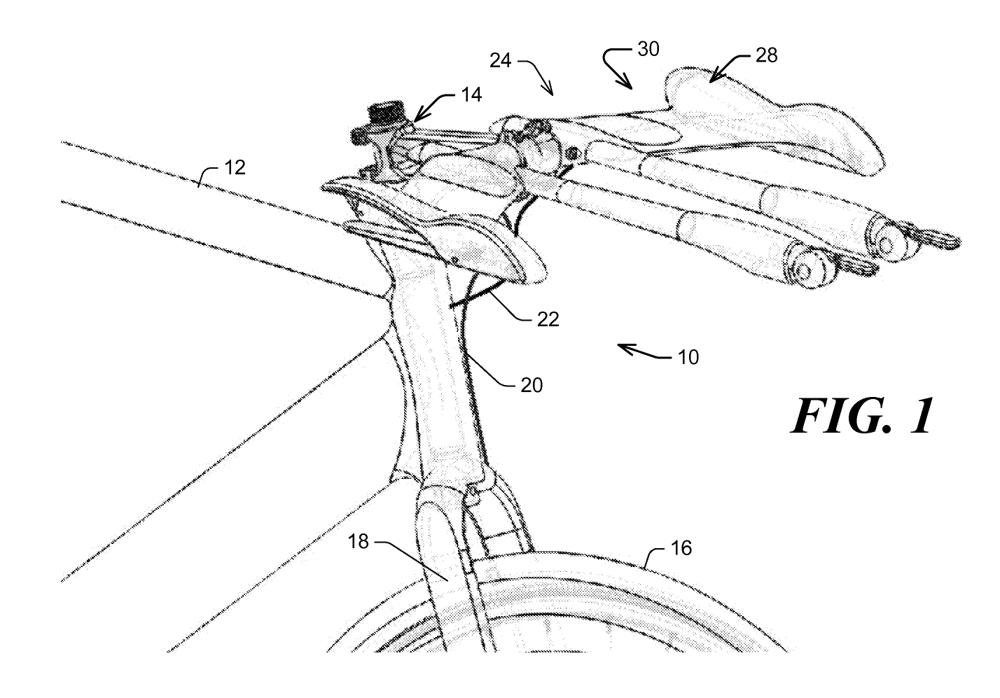

Referring to FIG. 1, there is shown bicycle 10 that includes a bicycle frame 12 coupled to a front mounting post 14, a front wheel 16 and a back wheel (not shown). A front brake 18 and a rear brake (not shown) are respectively coupled to the bicycle 10 for stopping rotation of the front wheel 16 and the back wheel. One end of a front brake cable 20 engages with the front brake 18, and one end of a rear brake cable 22 engages with the rear brake. Front mounting post 14 is coupled to handlebar 24.

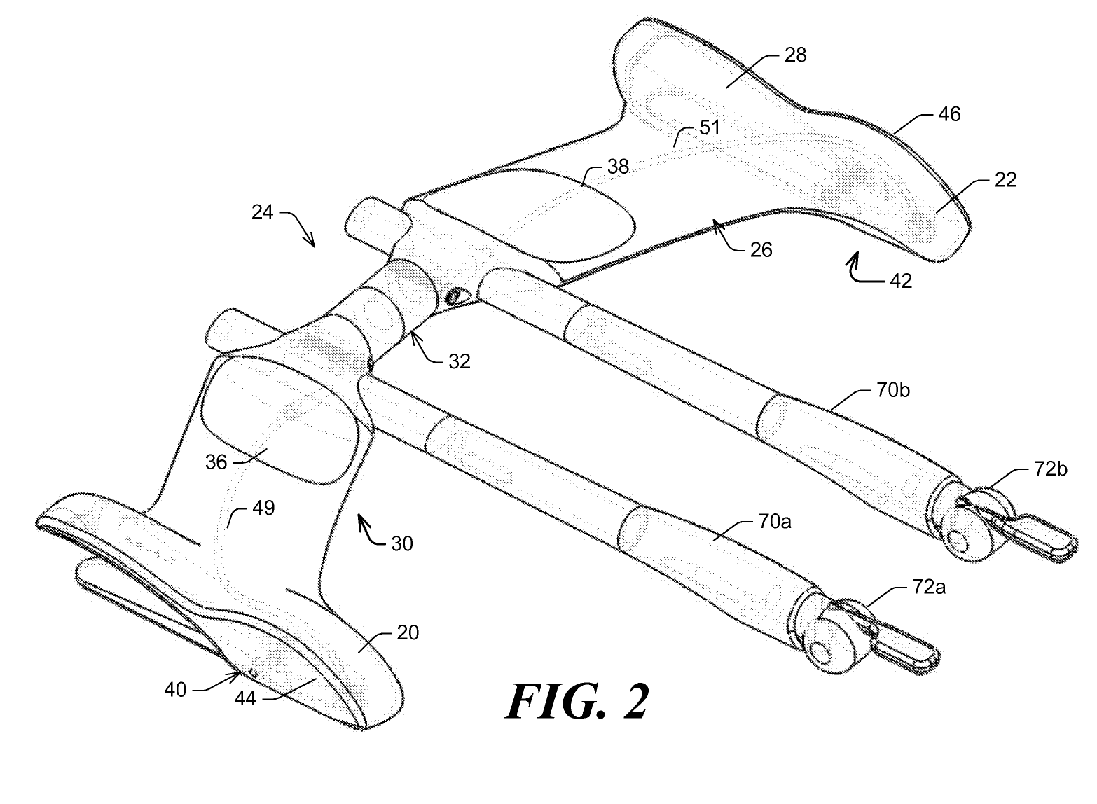

Referring to FIGS. 2-4, handlebar 24 that includes an elongated member 26 having a top 28 and a bottom 30. The elongated member 26 includes a narrow midsection 32 that attaches to the front mounting post 14 (FIG. 1) and member 26 extends outward from the front mounting post 14 in a substantially horizontal plane.

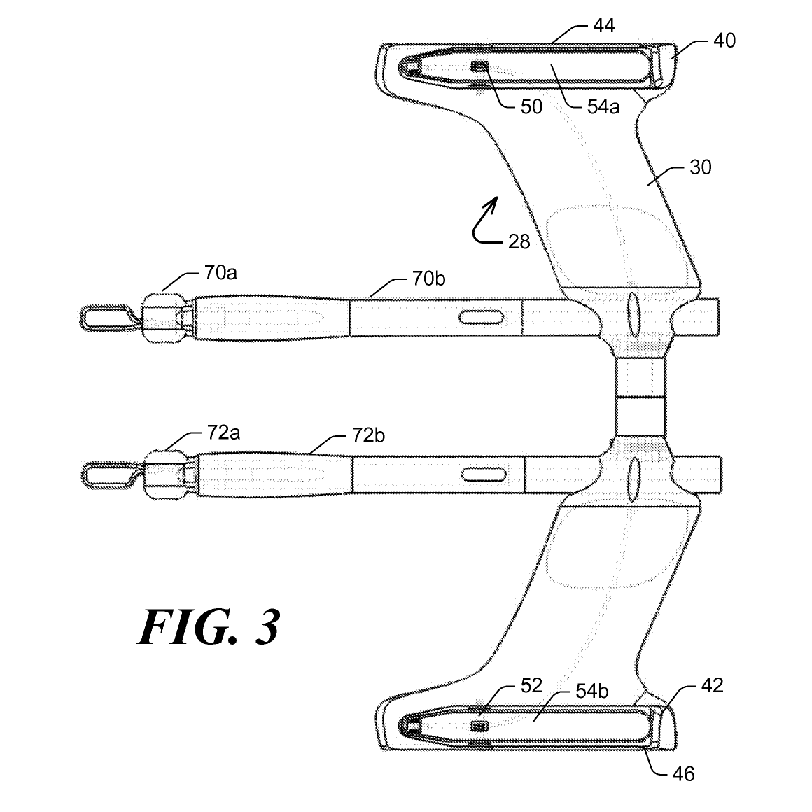

The elongated member 26 includes a pair of wide main sections 36, 38 respectively disposed adjacent the midsection 32. The pair of wide main sections 36 and 38 to support the arms of a bicycle rider on top 28 adjacent the wide main sections 36, 38. The member 26 forms a first recess 40 and a second recess 42 respectively disposed adjacent each end (44 and 46) of the member 26 on bottom 30. The first recess 40 and second recess 42 are formed on the bottom side 30 of the elongated member 26. In one implementation, recess 40 and 42 are wide enough and have a curvature to allow sufficient rotational movement of the lever 54a and/or 54b (FIGS. 3-5) to move the front cable 20 and/or rear brake cable 22 to engage the front break 18 and the rear brake. The elongated member 26 forms hollow tunnels 49 and 51 extending from at least one of the recesses 40 or 42 to the midsection 32 through which to receive the brake cables 20 and 22.

Referring to FIGS. 3-5, a first pin 50 and second pin 52 are coupled to the member 24 and respectively extend through the first recess 40 and second recess 42. The pin 50 (and pin 52) extends through a cavity 60 in at least one of handles 54a or 54b. The first brake handle 54a (also referred to as the front brake handle or front brake lever) and second brake handle 54b (also referred to as the rear brake handle or rear brake lever) rotatably couple to the first pin 50 and second pin 52 respectively. End 44 and end 46 of member 26 are at least partially opened starting at the location of the pin 50 (or pin 52) to enable the fingers of the user to engage with a back portion of the handle 54a (and handle 54b) and rotate handle 54a (and handle 54b).

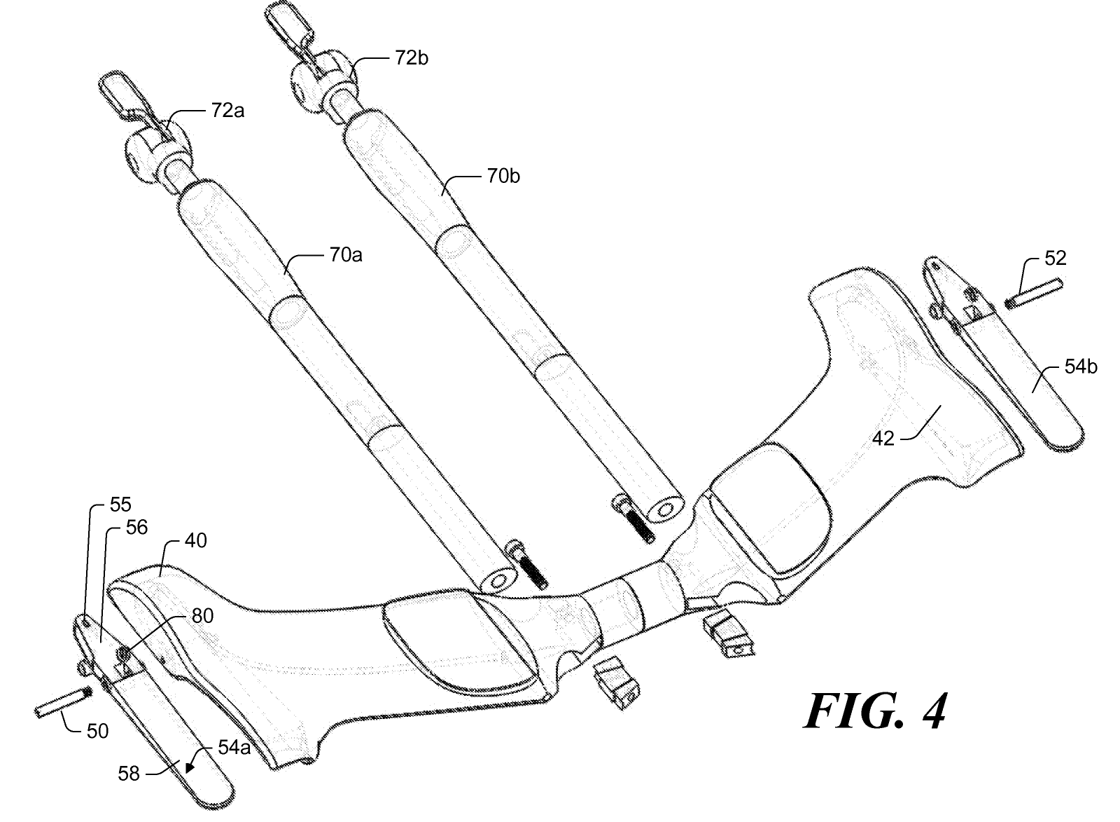

Referring to FIGS. 4-6, the first brake handle 54a (and likewise the second brake handle 54b) includes a front section 56 that extends from pin 50 forward away from the bicycle and a rear section 58 that extends from pin 50 backward toward the bicycle. At least one of the brake handles 54a is narrow at its forward portion or front section 56, and wider at a rearward portion or rear section 58. Handles 54a or 54b have its' rearward portion 58 with an upper surface 62 and lower surface 64 that tapers from the cavity 60 from where the pin 50 or pint 52 extends through the at least one of the handles 54a (or handle 54b).

Referring to FIGS. 2-5, the first brake handle 54a and the second brake handle 54b respectfully are at least partially located within the first recess 40 and second recess 42. Each side 44 and side 46 of member 26 is at least partially opened starting at the location of the pin 50 (or 52) to enable the fingers of the bicycle rider to engage with and rotate the rear section 58 of the brake handle 54a (or 54b) without obstruction.

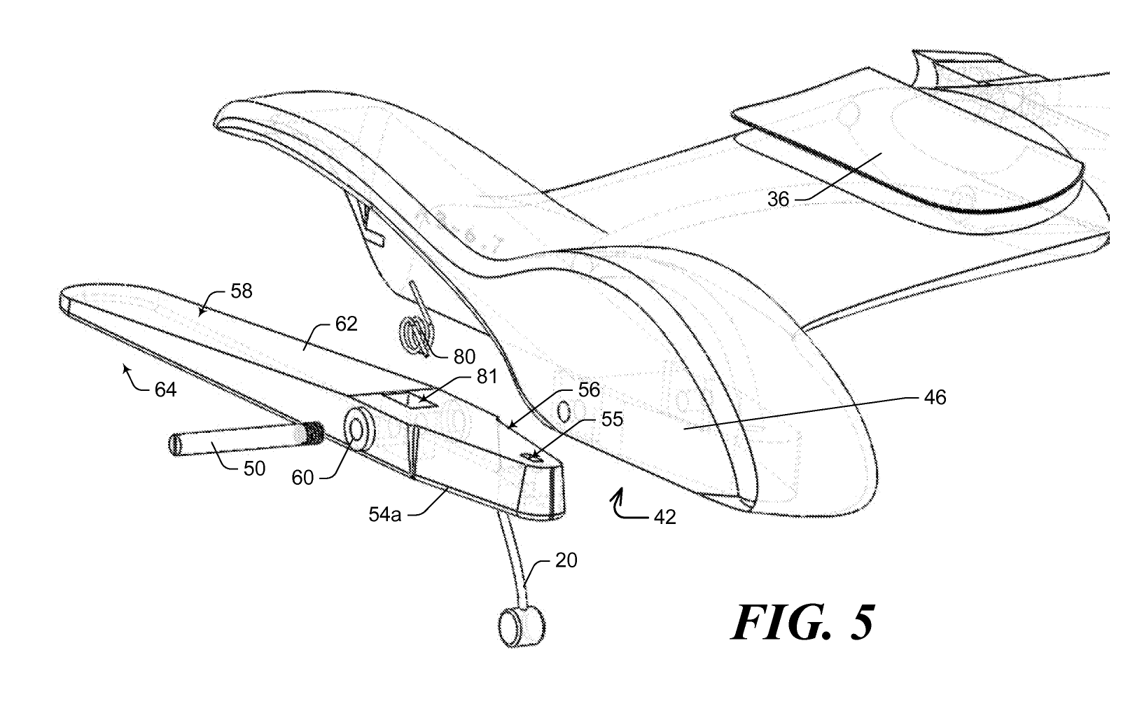

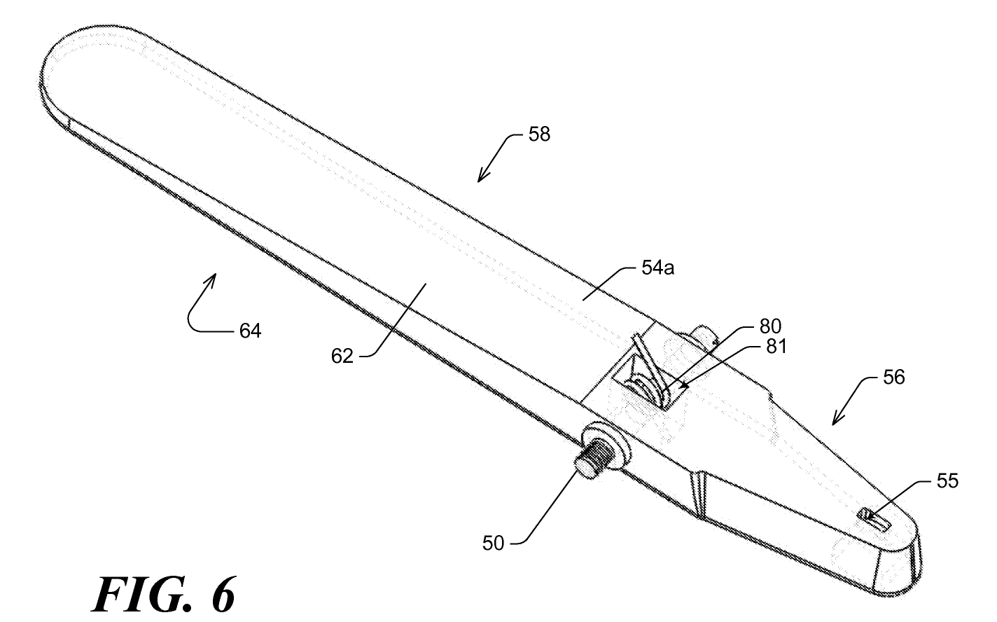

Referring to FIGS. 5-6, a spring 80 is mounted on at least one of the pins 50 (or 52) and is inserted via aperture 81. Spring 80 engages with the elongated member 26 and with at least one of the brake handles 54a or 54b. The spring 80 returns the handle 54a and/or 54b to an original position after the partial rotation of brake handle 54a and/or 54b by the bicycle user about the at least one of the pins 50 or 52. Referring to FIGS. 5-6, brake handle 54a and 54b includes a cavity 55 disposed in its front section 56 to receive the brake cable 20 and 22 respectively.

Referring to FIGS. 1, and 5-6, the front section 56 of the front brake handle 54a engages with another end of front brake cable 20, and the front section 56 of the rear brake handle 54b engages another end of rear brake cable 22 to brake the bicycle. This braking occurs in response to the fingers of a bicycle rider (not shown) engaging with either the rear section 58 of the front brake handle 54a to partially rotate the front brake handle 54a about the first pin 50 within the recess 40, or the rear brake handle 54b to partially rotate the rear brake handle 54b about the second pin 52 within the recess 42. The forward section (or portion) of at least one of the brake handles 54a and/or 54b is covered by the elongated member 26 within the recess 40 (or 42) at least prior to the rotation of at least one of the brake handles 54a and/or 54b.

Referring to FIGS. 1-4, a pair of elongated tubes 70a and 70b extend from midsection 32 of the member 26 to a distal end. Each distal end 74a and 74b of the pair of elongated tubes 70a and 70b are respectively connected to a bicycle gear shifter 72a and 72b. The bicycle gear shifters 72a and 72b are connected via a gear cable (not shown) to the gears of a bicycle.

During operation of the bicycle, the arms of a bicycle rider are supported on the top adjacent the wide main sections when the elongated member is attached to the front mounting post. The bicycle 10 is braked using the hands of the bicycle rider reaching below the attached member 26 adjacent the first end 44 or the second end 46 of member 26 to engage a rear section 58 of the first brake handle 54a or the second brake handle 54b. The bicycle rider at least partially rotates the first brake handle 54a or the second brake handle 54b about the first pin 50 or the second pin 52 within the recess 40 or 42. Once the brake handle 54a or 54b is rotated, the spring 80 generates a force to automatically return the handle 54a or 54b to its original position. Top of handle 54a and/or handle 54b rests against a portion of a wall of recess 40 and/or recess 42 respectively to maintain the original position of handles 54a, 54b in a nearly neutral and/or horizontal position.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A bicycle handlebar comprising:
an elongated member having a top and a bottom, the elongated member including a narrow midsection configured to attach to a front mounting post of a bicycle and extend outward from the front mounting post in a substantially horizontal plane, the elongated member including a pair of wide main sections respectively disposed adjacent the midsection and adapted to support arms of a bicycle rider on the top when the elongated member is attached to the front mounting post, the member forming a first and second recess respectively disposed adjacent each end of the member on the bottom;
a first and second pin coupled to the member and respectively extending through the first and second recess; and
a first and second brake handle rotatably coupled to the first and second pin respectively, the first and second brake handle respectfully at least partially disposed within each recess, the brake handles configured to respectively couple to a front and rear brake cable of a bicycle to brake the bicycle in response to a partial rotation of the first or second brake handle about the first pin or the second pin within the recess by the bicycle user.

2. The bicycle handlebar as recited in claim 1, wherein the first and second recesses are formed on the bottom side of the elongated member, and wherein at least a forward section of at least one of the brake handles is covered by the elongated member within the recess at least prior to the rotation of at least one of the handles.

3. The bicycle handlebar as recited in claim 2, wherein at least one of the handles is narrow at the forward portion, and wider at a rearward portion.

4. The bicycle handlebar as recited in claim 2, wherein the pin extends through a cavity in at least one of the handles, and wherein the at least one of the handles has a rearward portion with an upper and lower surface that tapers from the cavity from where the pin extends through the at least one of the handles.

5. The bicycle handlebar as recited in claim 1, further comprising:
a pair of elongated tubes extending from midsection of the member to a distal end, each distal end of the pair of elongated tubes respectively connected to a bicycle gear shifter.

6. The bicycle handlebar as recited in claim 1, further comprising a spring mounted on at least one of the pins that engages with the member and with at least one of the handles to return the at least one of the handles to its original position after the partial rotation of at least one of the brake handles by the bicycle user about the at least one of the pins.

7. The bicycle handlebar as recited in claim 1, wherein the elongated member forms a hollow tunnel extending from at least one of the recess members to the midsection through which to receive the brake cable.

8. A method of braking a bicycle, the method comprising:
providing an elongated member with a top, a bottom, and a narrow midsection;
forming in the elongated member:
a) a pair of wide main sections adjacent the narrow midsection, and
b) a first recess and a second recess adjacent each end of the member on the bottom;
coupling a first and second pin to the member through the first and second recess respectively;
rotatably coupling a first and second brake handle to the first and second pin respectively such that the first and second brake handle are at least partially disposed within each recess;
attaching the narrow midsection to a front mounting post of a bicycle such that the elongated member extends outward from the front mounting post in a substantially horizontal plane;
coupling the brake handles to a front brake cable and a rear brake cable of a bicycle respectively;
coupling the front brake cable to a bicycle front brake and the rear brake cable to a bicycle rear brake;
supporting arms of a bicycle rider on the top adjacent the wide main sections when the elongated member is attached to the front mounting post; and
braking the bicycle with hands of the bicycle rider reaching below the attached member adjacent the first end or the second end to engage a rear section of the first or the second brake handle to at least partially rotate the first or the second brake handle about the first pin or the second pin within the recess.

9. The method as recited in claim 8, further comprising:
forming the first and second recesses on the bottom of the elongated member, and
substantially covering at least a front end of the first or second handle with the elongated member within the recess prior to bicycle user rotating the first or the second handle.

10. The method as recited in claim 9, further comprising:
forming the first or the second handle to be narrow at the front section, and wider at a rear section.

11. The method as recited in claim 9, further comprising:
extending at least one of the pins through a cavity in at least one of the handles, and
tapering an upper and lower surface of a rear section of the at least one of the handles from the cavity to a rear end of the at least one of the handles.

12. The method as recited in claim 8, further comprising:
extending a pair of elongated tubes from the midsection of the member to a distal end,
connecting each distal end of the pair of elongated tubes respectively to a bicycle gear shifter, and
shifting gears of the bicycle with the bicycle gear shifter.

13. The method as recited in claim 8, further comprising:
engaging a spring mounted on at least one of the pins with the member and with the at least one of the handles to automatically return the at least one of the handles to an original position of the at least one of handles after the partially rotating the first or second brake handle by the bicycle user about the at least one of the pins.

14. The method as recited in claim 9, further comprising:
forming in the elongated member a hollow tunnel that extends from at least one of the recess members to the midsection; and
extending a least one of the front brake cable or the rear brake cable through the hollow tunnel.

15. A bicycle comprising:
a bicycle frame with a front mounting post;
a front wheel and a back wheel coupled to the bicycle frame;
a front brake and a rear brake for stopping rotation of the front wheel and back wheel;
a front cable for engaging at one end with the front brake, and a rear cable for engaging at one end with the rear brake;
a handlebar including:
an elongated member having a top and a bottom, the elongated member including a narrow midsection attached to the front mounting post and extending outward from the front mounting post in a substantially horizontal plane, the elongated member including a pair of wide main sections respectively disposed adjacent the midsection, the pair of wide main sections adapted to support the arms of a bicycle rider on the top adjacent the wide main sections, the member forming a first and second recess respectively disposed adjacent each end of the member on the bottom;
a first and second pin coupled to the member and respectively extending through the first and second recess; and
a first and second brake handle rotatably coupled to the first and second pin respectively, the first and second brake handles including a front section that extends from at least one of the pins forward away from the bicycle and a rear second that extends from the at least one of the pins backward toward the bicycle, the first and second brake handle respectfully at least partially disposed within the first and second recess, the front section of the front brake handle engaging with the front brake cable and the front section of the rear brake handle engaging the rear brake cable of the bicycle to brake the bicycle in response to a bicycle rider engaging with the rear section of:
a) the front brake handle to partially rotate the front brake handle about the first pin within the recess, or
b) the rear brake handle to partially rotate the rear brake handle about the second pin within the recess.

16. The bicycle as recited in claim 15, wherein the first and second recesses are formed on the bottom side of the elongated member, and wherein at least the front section of the rear and front brake handles is covered by the elongated member within the recess at least prior to the rotation of the front or rear brake handle.

17. The bicycle as recited in claim 16, wherein at least one of the pins extends through a cavity in the front or rear brake handle, and wherein the front or rear brake handle has an upper and lower surface that tapers inward from the cavity from where the at least one of the pins extends through the front or rear brake handle.

18. The bicycle as recited in claim 15, further comprising:
a pair of elongated tubes extending from midsection of the member to a distal end, each distal end of the pair of elongated tubes respectively connected to a bicycle gear shifter.

19. The bicycle as recited in claim 15, further comprising a spring mounted on at least one of the pins that engages with the member and with the at least one of the front brake handle or the rear brake handle to return the at least one of the front or the rear brake handle to its original position after the partial rotation about at least one of the pins of the front or the rear brake handle by the bicycle user.

20. The bicycle as recited in claim 15, wherein the elongated member forms a hollow tunnel extending from at least one of the recess members to the midsection through which to receive the front brake cable or the rear brake cable.
